(19) United States
(12) Patent Application Publication
(10) Pub. No.: US 2004/0123739 A1
(43) Pub. Date: Jul. 1, 2004

(54) Anion-generating device

(76) Inventor: Te-Chin Jan, Taipei (TW)

Correspondence Address: BRUCE H. TROXELL, SUITE 1404, 5205 LEESBURG PIKE, FALLS CHURCH, VA, 22041, US

(21) Appl. No.: 10/737,738

(22) Filed: Dec. 18, 2003

Related U.S. Application Data
(63) Continuation-in-part of application No. 10/180,035, filed on Jun. 27, 2002.

(51) Int. Cl. B03C 3/68

(52) U.S. Cl. 96/18

(57) ABSTRACT

The invention is to provide an anion-generating device, which can generate and spread anions to the air by a pinpoint array, and dust particles in the air can be adsorbed on its internal dust-collecting device, wherein the internal dust-collecting device is designed as a modular structure. Further, when a short circuit occurs in the internal circuit of the anion-generating device, the high voltage power source can be automatically switched off for protecting the anion-generating device. By the arrangement of a switch device, the anion-generating device can be resumed to normal operation after being automatically switched off. The invention controls and generates high voltage power by a design of a controlling device, which includes a logic controlling circuit and a high voltage power generating circuit, wherein the logic controlling circuit comprises a switch device and an indicating device. The indicating device can indicate the operation state, and the high voltage power generating circuit can generate high voltage power to adsorb dust and generate anions.

### FIELD OF THE INVENTION

The invention relates to an anion-generating device, particularly to an anion-generating device which can generate anions by a pinpoint array, and in which an internal dust-collecting device is designed as a modular structure for being easily drawn to replace or clean. Further, when a short circuit occurs in the internal circuit, it can be automatically switched off to protect the anion-generating device and, by the arrangement of a switch device, the anion-generating device can be resumed to normal operation after being automatically switched off. This application is a Continuation-in-part (CIP) application of U.S. patent application Ser. No. 10/180,035, which was filed on Jun. 27, 2002 and is now pending.

### BACKGROUND OF THE INVENTION

Accordingly, the structure of a common anion-generating device applies the principle of potential difference to generate an electric-dizzy discharge with a high voltage. By the ionized metal thread in the anion-generating device, the air particles are ionized, charged, become anions, and then spread to the indoors, such that the effect of containing more anions in the air is fulfilled.

However, when the air enters the cleaner, most dust particles and impurities in the air will follow the air to flow into the cleaner, such that the ionized thread in the cleaner is easily broken up because of oxidation, or the internal conductive plate is oxidized to influence the effect of electrical conduction. Thus, it is impossible to further generate enough anions. Furthermore, when the dust on the conductive plate is accumulated to a certain level or, because there are too many dust accumulated in the conductive plate and the ionized thread or, because insects (e.g. mosquito and fly) enter the interior of the anion-generating device to cause the disasters of fire, electric leakage, or short circuit, etc., the normal operation of the anion-generating device is influenced, the efficiency is decreased, and many breakdowns will occur.

Therefore, the user must open the interior of the anion-generating device regularly and, after taking apart the device, both the conductive plate and the ionized thread are then cleaned and maintained. Not only the cleaning procedure is tedious, but also it is easy to damage the internal structure of the anion-generating device during the taking-apart procedure because of carelessness. Particularly, when there are objects entering the interior of the anion-generating device, usually damages will be incurred by the short circuit of the anion-generating device and, it is also too late to open the machine for cleaning at that situation.

Therefore, if the shortcomings of the prior arts described above can be improved, then the unsolved problem of the prior arts can be solved effectively and, that is why the invention is an innovative breakthrough in this technical field.

### SUMMARY OF THE INVENTION

In consideration of this, in order to improve the shortcomings of the prior arts, the inventor, through a long time of devotion, research, and experiment, has finally designed an anion-generating device of the invention. The main objectives of the invention are to cause the dust in the air taken into the cleaner to be adsorbed on dust-collecting plates by arranging an internal dust-collecting device located adjacently to the air inlet and, to generate anions wind by a pinpoint array. In the invention, the internal dust-collecting device is designed as a modular structure for being easily cleaned and maintained such that the usage life of the anion-generating device can be further extended.

A further objective of the invention is to design a controlling device in the interior of the anion-generating device for controlling the internal circuit and the operation of the internal dust-collecting module wherein, when a short circuit happens, the operation of the anion-generating device is stopped to prevent it from damaging and, by the arrangement of a switch device, the operational state is resumed and, by the design of an indicating device, the user will thereby understand the operation state in the anion-generating device.

Another objective of the invention is to exhaust the anions generated by the pinpoint array into the environment with cleaned air such that the amount of anions in the air is increased and it is beneficial to human body. In the invention, the pinpoint array is grounded and arranged at the bottom of the exhaust outlet. The internal dust-collecting module is constructed by two grounded saw-tooth sheets and two parallel conductive plates connected to negative high voltage for adsorbing dust in the air.

The invention comprises a front shell, a rear shell, an upper lid, a lower shell, an internal dust-collecting module, a pinpoint array, and a controlling device, wherein the front shell has exhaust outlet and the rear shell has air inlet. The air inlet is used for delivering the outside air into the interior of the anion-generating device, and the exhaust outlet is used for sending the cleaned air that has passed through the internal dust-collecting module to the outside environment, while the anions generated by the pinpoint array are spread into the cleaned air. The upper lid can be opened for drawing out or replacing the internal dust-collecting module connected with the upper lid; that is, the upper lid and the internal dust-collecting module are designed as a whole such that the user can easily clean and maintain the conductive plates in the internal dust-collecting module.

The controlling device comprises a logic controlling circuit and a high voltage power generating circuit. The logic controlling circuit controls the electric operation of the anion-generating device and can automatically switch off the operation of dust-collecting operated by the internal dust-collecting module when a short circuit occurs in the first electrode portion and the second electrode portion of the internal dust-collecting module, while the high voltage power generating circuit is connected to the logic controlling circuit and is controlled by the logic controlling circuit for generating the high voltage power needed by the second electrode portion.

For better recognizing and understanding the characteristics, objectives, shapes and functions of the invention, a detailed description together with accompanying drawings are presented as follows.

### BRIEF DESCRIPTION OF THE DRAWINGS

FIG. 1 is a three-dimensional diagram of a preferred embodiment of the invention.

FIG. 2 is the front view of a preferred embodiment of the invention.

FIG. 3 is the rear view of a preferred embodiment of the invention.

FIG. 4 is a three-dimensional decomposed diagram of a preferred embodiment of the invention.

FIG. 5 is an internal circuit block diagram of a preferred embodiment of the invention.

FIG. 6 is the internal dust-collecting module diagram of a preferred embodiment of the invention.

FIG. 7 is a diagram depicting internal dust-collecting of a preferred embodiment of the invention.

FIG. 8 is a diagram depicting anions generated by the pinpoint array of a preferred embodiment of the invention.

### DETAILED DESCRIPTION OF THE INVENTION

The invention directs to an anion-generating device, particularly to an anion-generating device which can generate anions by a pinpoint array, and in which an internal dust-collecting device is designed as a modular structure for being easily drawn by users to replace or clean such that the usage life of the anion-generating device can be further extended. Further, when a short circuit occurs in the internal circuit of the anion-generating device, the internal high voltage power source can be automatically switched off to protect the anion-generating device and, by the arrangement of a switch device, the anion-generating device can be resumed to normal operation after being automatically switched off.

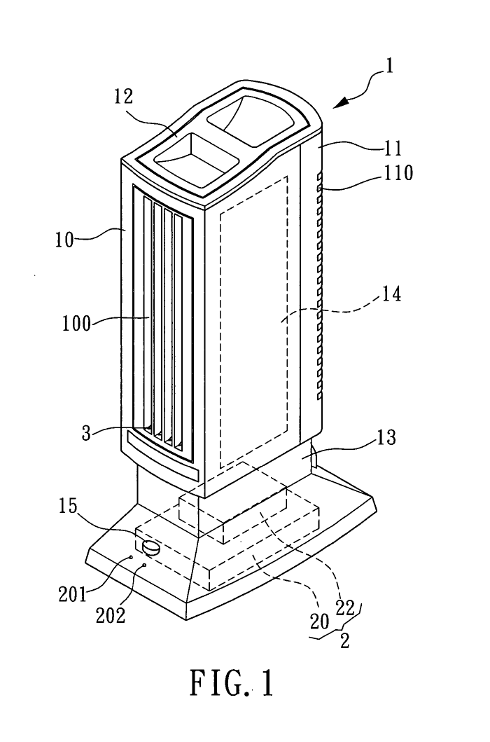

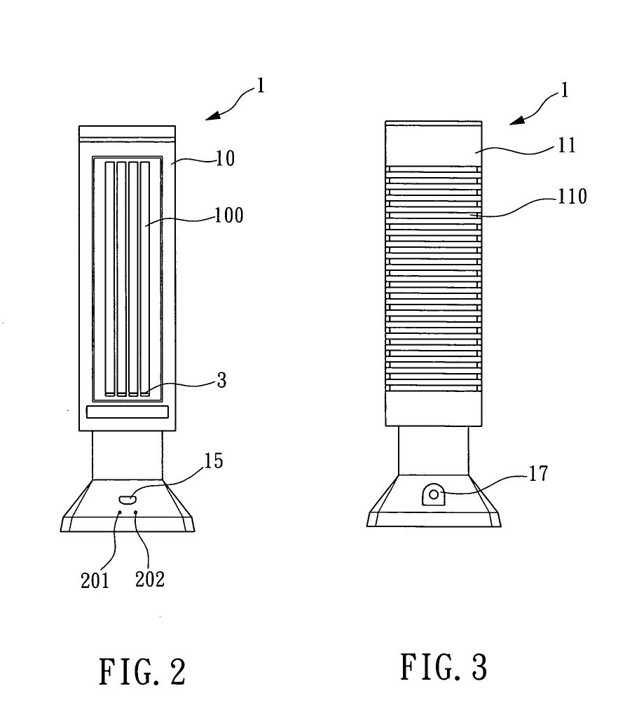

Please refer to FIGS. 1-3, wherein FIG. 1 is a three-dimensional diagram of a preferred embodiment of the invention and FIG. 2 and FIG. 3 are the front view and the rear view of the invention, respectively. As shown in FIG. 1, the exterior part of the anion-generating device 1 according to the invention is a shell structure, which comprises a front shell 10, a rear shell 11, a lower shell 13 supporting the anion-generating device 1, an upper lid 12, an internal dust-collecting module 14, a controlling device 2, and a pinpoint array 3. The front shell 10 has exhaust outlet 100, while the rear shell 11 has air inlet 110. The air inlet 110 delivers the outside air into the interior of the anion-generating device 1 and the exhaust outlet 100 sends the air that is dust-collected within the anion-generating device 1 and spreads the anions generated by the pinpoint array 3 to the outside environment. The upper lid 12 can be opened to draw out the internal dust-collecting module 14 connected with the upper lid for facilitating the user to clean or maintain. Of course, after cleaning and maintaining, the upper lid 12 with the internal dust-collecting module 14 is then inserted back into the interior of the anion-generating device 1. Thus, the upper lid 12 and the internal dust-collecting module 14 can be designed integrally as a whole. During cleaning, the user can draw up the upper lid 12, while the internal dust-collecting module 14 is also drawn out following the upper lid 12, so the cleaning and maintaining processes are facilitated.

A controlling device 2, arranged in the interior of the anion-generating device 1, can control the entire operation and function of the anion-generating device 1 and comprises two circuit substrates of the high voltage power generating circuit 22 and the logic controlling circuit 20. When the anion-generating device 1 is incurred the situation of a short circuit, the controlling device 2 can automatically switch off the internal circuit operation of the anion-generating device 1, then the user can actuate the switch 15 to remove the situation of short circuit and, at this time, the anion-generating device 1 is still protected under the switched-off situation and, when the user actuate the switch 15 again, the anion-generating device is resumed to the normal operation. When the anion-generating device 1 is under the situation of normal operation, the switch 15 can switch on or switch off the anion-generating device 1; that is, its function is to control the power source. So, the switch 15 has different functions for the anion-generating device 1 under the normal operation state or when a short circuit occurs.

Furthermore, an indicating device is arranged in the exterior of the anion-generating device 1, such as light emitting diodes 201 and 202, which can indicate the working situation of the anion-generating device 1, for example, in a state of short circuit or out of a state of short circuit. As shown in FIG. 3, a DC power connector 17 connected to a household power socket can convert the household AC power into the DC power needed by the anion-generating device.

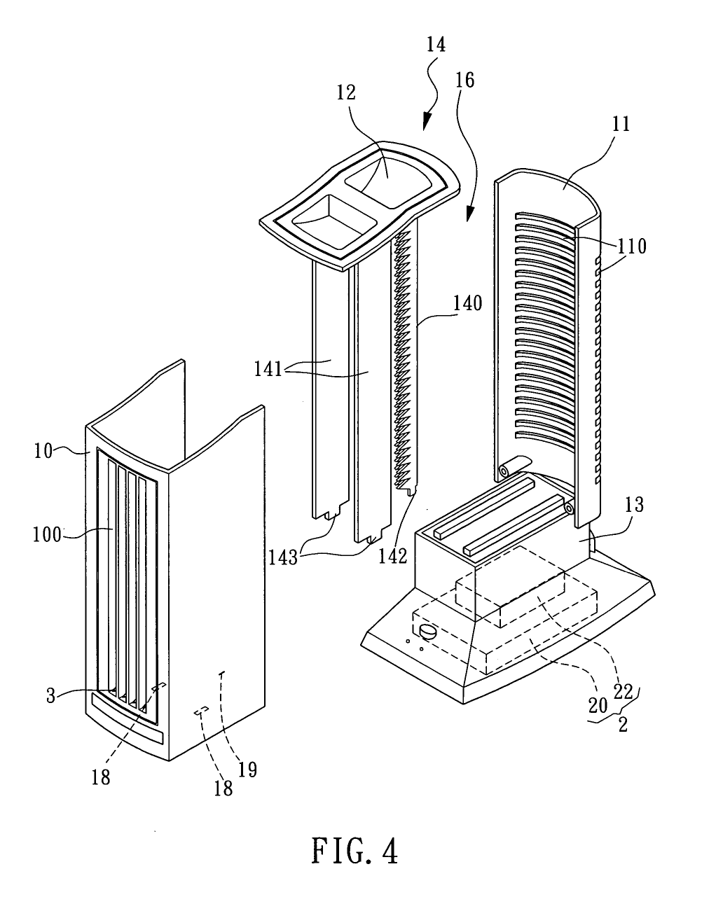

Please refer to FIG. 4, which is a three-dimensional decomposed diagram of a preferred embodiment of the invention. The invention comprises a shell body including a front shell 10, a rear shell 11, and a lower shell 13, wherein an accommodation space 16 is formed within the front shell 10 and the rear shell 11 and can accommodate the internal circuit device and the internal dust-collecting module 14. Reeds 18 and 19 are arranged within the front shell 10, wherein the reed 19 receives a connection terminal 142 at the bottom of the first electrode portion 140 of the dust-collecting module 14 and the reeds 18 receive connection terminals 143 of the second electrode portion 141. The reeds 18 are connected to a negative high voltage power source of the high voltage power generating circuit 22, and the reed 19 is grounded. Of course, since the function of the reeds 18 and 19 is to provide connections with the connection terminals 142 and 143, the reeds 18 and 19 can also be designed in other forms for connecting to the terminals 142 and 143. Besides, a pinpoint array 3 is arranged at the bottom of the exhaust outlet 100 and grounded.

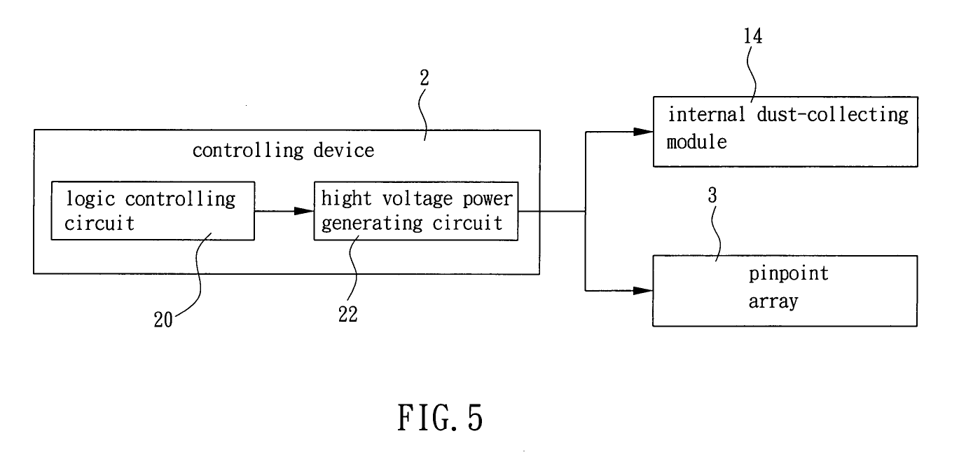

Please refer to FIG. 5, which is an internal circuit block diagram of a preferred embodiment of the invention. Within the anion-generating device of the invention, there are a controlling device 2, an internal dust-collecting module 14, and a pinpoint array 3. The internal dust-collecting module 14 includes a first electrode portion 140 and a second electrode portion 141. The first electrode portion 140 is constructed by two grounded saw-tooth sheets, which can cause dust in the air to become zero potential. The second electrode portion 141 is structured as two pieces of conductive plates connected to negative high voltage power output from the high voltage power generating circuit 22 for adsorbing the dust particles contained in the air. Adsorbing the dust particles contained in the air via the two conductive plates of the second electrode portion 141, such that the impurities contained in the air can be filtered naturally and the effect of cleaning is produced. Simultaneously, a high voltage difference between the second electrode portion 141 and the pinpoint array 3 enables the pinpoint array 3 to generate anions, which are then spread in the cleaned air.

The controlling device 2 includes a high voltage power generating circuit 22 and a logic controlling circuit 20, wherein the logic controlling circuit 20 controls the electrical operation of the anion-generating device and can automatically switch off the operation of the internal dust-collecting module 14 when a short circuit occurs in the first electrode portion 140 and the second electrode portion 141. The high voltage power generating circuit 22 is connected with the logic controlling circuit 20 and is controlled by the logic controlling circuit 20 for generating the high voltage power needed by the second electrode portion 141.

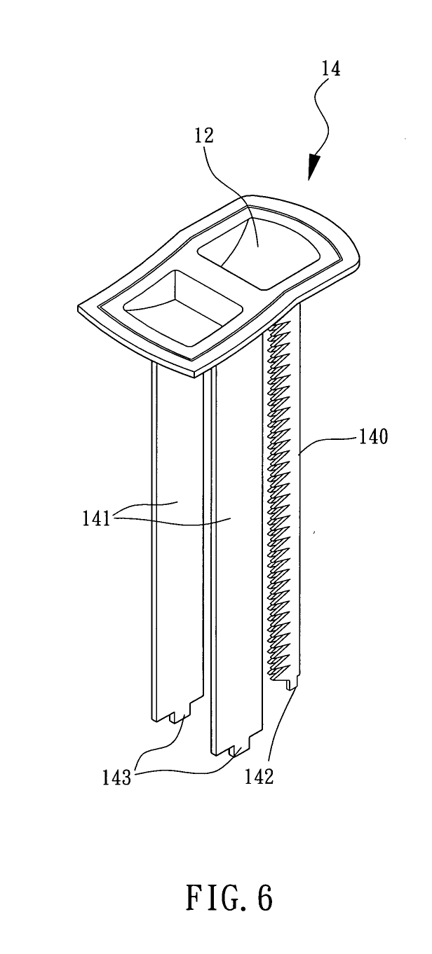

Please refer to FIG. 6, which is the internal dust-collecting module diagram of a preferred embodiment of the invention. As shown in FIG. 6, the internal dust-collecting module 14 is integrally formed as a whole by the first electrode portion 140 and the second electrode portion 141, such that the internal dust-collecting module 14 can be drawn out from or inserted into the shell body of the anion-generating device. Thus, the internal dust-collecting module 14 can be designed as a modular frame structure for being easily drawn out from or inserted into the shell body of the anion-generating device and the main purpose of which is letting the user can easily clean and maintain the first electrode portion and the second electrode portion. The first electrode portion 140 is formed by two grounded saw-tooth sheets with plurality of interlaced pinpoints and is located adjacently to the air inlet to take the outside air in and make it be zero potential. The second electrode portion 141 is supplied with a negative high power source and structured as two pieces of conductive plates and is located adjacently to the exhaust outlet to adsorb dust in the air coming from the first electrode portion.

When the dust particles accumulated on the conductive plates to a certain degree or, when the conductive plates contact with the air too long and are oxidized or, because some objects such as insects, mosquitoes, and flies, etc., fly or drop onto the conductive plates, the normal operation of the anion-generating device will be influenced to cause decrease of efficiency or other dangerous situation of breakdown so, through the modulization of the internal dust-collecting module, the device will be easily cleaned and these shortcomings can be avoided.

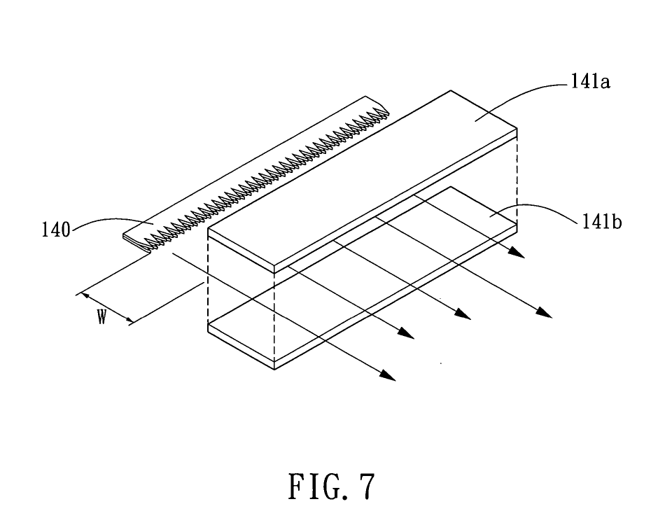

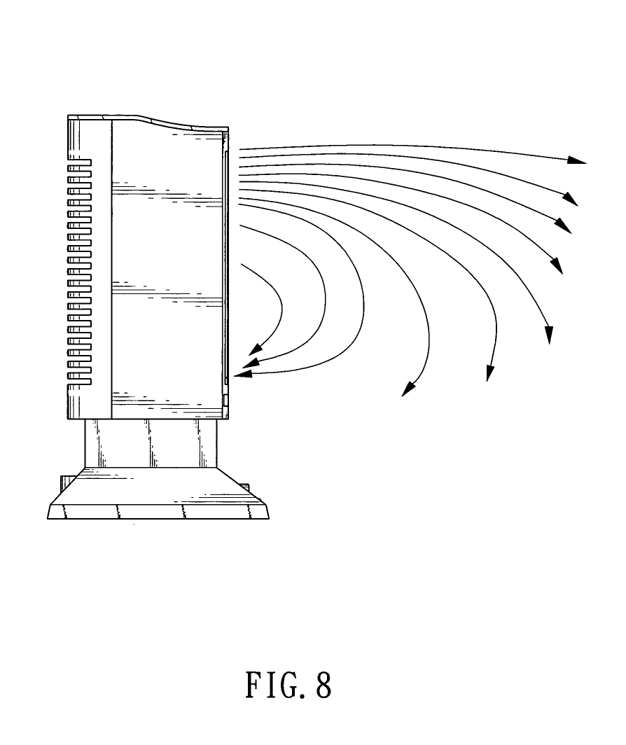

Please refer to FIG. 7, which is a diagram depicting internal dust-collecting of a preferred embodiment of the invention. As shown in FIG. 7, the first electrode portion 140 is kept an appropriate distance W from the second electrode portion 141. Since the first electrode portion 140 is grounded, the dust and air around it become a zero potential. The second electrode portion 141 is connected to a negative high voltage power and constructed by two conductive plates 141a and 141b, which will adsorb the dust coming from the first electrode portion 140. Thus, the dust in outside air will be filtered during the process of flowing via the first electrode portion to the second electrode portion. The two conductive plates 141a and 141b of the second electrode portion are arranged in parallel, while the first electrode portion 140 is parallel with the conductive plates 141a and 141b and located at the distance W before the two conductive plates. That is, when both of the conductive plates 141a and 141b are extended a distance W toward the first electrode portion 140, they can be parallel with the first electrode portion 140 and, in the meantime, it can be found that the first electrode portion 140 is just located in the middle plane between the extensive positions of the two conductive plates 141a and 141b.

FIG. 8 is a diagram depicting anions generated by the pinpoint array of a preferred embodiment of the invention. As shown in FIG. 8, the cleaned air which has been dust-collected internally flows out via the exhaust outlet 100.

Simultaneously, since a pinpoint array 3 is arranged at the bottom of the outlet 100, a high voltage difference between the pinpoint array 3 and the second electrode portion 141 will make the pinpoint 3 generate anions when the cleaned air flows out of the outlet 100. A few of these anions are adsorbed by the pinpoint array 3, and most of the anions are sent out forward following the cleaned air via the exhaust outlet 100.

The purpose of such design is to let the air can move in a direction of flow; that is, the air outside of the anion-generating device can enter the device from the air inlet and flow through the internal dust-collecting module and the pinpoint array to generate cleaned air and anions, then the cleaned air leave the device via the exhaust outlet and those anions are spread to the outside environment.

Accordingly, the above description is only an illustration for the preferred embodiment according to the invention. However, the practical application of the invention is not restricted to this description, because any kind of variation that can be easily conceived by those who are skilled in the art according to the spiritual range of the invention is all covered by the claims of the patent claimed thereinafter.

To sum up, the invention has the characteristics of simple structure and easy maintenance. Particularly, when the internal dust-collecting module needs to be cleaned, because it is designed as a module, the cleaning procedure is become easy; that is, the module can be immersed in the water or scrubbed. The invention not only can clean the air, but also has the effect to increase the amount of anions in the air. Compared with the products of the prior arts, the invention can indeed prevent the occurrences of short circuit, electricity leakage, or firing, etc., which are caused by the dust particles accumulated on the internal surfaces of the anion-generating device. Particularly, when a short circuit occurs, the anion-generating device will be switched off immediately to avoid any damage, so the shortcomings of the prior arts—because the dust particles are easily accumulated on the surface of the anion-generating device, the anion-generating device is caused to operate abnormally and the expected function can not be fulfilled—can be overcome. Furthermore, according to the invention, the structure of the anion-generating device is simplified, the cost is cheaper, and the function of anion-generation can be better achieved, thus the invention improves effects of some specified functions.

What is claimed is:

1. An anion-generating device, comprising:
a shell body, in which an accommodation space is formed therein, and an air inlet and an exhaust outlet are arranged on said shell body for facilitating the outside air to enter the device from said air inlet, to flow through the dust-collecting and anion-generating processes operated in said accommodation space, and to leave the device via said exhaust outlet;
an internal dust-collecting module, which is disposed in said shell body, including:
a first electrode portion, which is located adjacently to said air inlet and is grounded;
a second electrode portion including at least two conductive plates, said second electrode portion is located adjacently to said exhaust outlet and is connected to a negative high voltage power, said second electrode portion is used for adsorbing dust particles in the air flowing from said first electrode portion to said second electrode portion;
a controlling device, including:
a logic controlling circuit, which is used for controlling the electrical operation of said anion-generating device and can automatically switch off the operation of said anion-generating device when a short circuit occurs in said first electrode portion and said second electrode portion;
a high voltage power generating circuit, which is connected to said logic controlling circuit and is controlled by said logic controlling circuit for generating a high voltage power needed by said second electrode portion; and
a pinpoint array, which is arranged at the bottom of said exhaust outlet, is used for generating anions and spreading them in the air when the air flows through said internal dust-collecting module and leaves the device via said exhaust outlet.

2. The anion-generating device according to claim 1, wherein the internal dust-collecting module further comprises an upper lid such that said internal dust-collecting module and said upper lid are designed integrally as a whole.

3. The anion-generating device according to claim 1, wherein said internal dust-collecting module is a modular frame structure including the first electrode portion and the second electrode portion, and said modular frame structure can be taken out from and inserted into said shell body in a whole.

4. The anion-generating device according to claim 1, wherein said first electrode portion is kept an appropriate distance from said second electrode portion, such that the air passes said first electrode portion and flows through the conductive plates of said second electrode portion.

5. The anion-generating device according to claim 1, wherein said first electrode portion is constructed by two saw-tooth sheets with plurality of interlaced pinpoints.

6. The anion-generating device according to claim 1, wherein said second electrode portion is constructed by two conductive plates arranged in parallel, and said second electrode portion will be parallel to said first electrode portion by extending a certain distance toward said first electrode portion to make the first electrode portion located between the two conductive plates of the second electrode portion.

7. The anion-generating device according to claim 1, wherein at least one switch is further included, said switch is connected to said controlling device and can resume said anion-generating device to normal operation when a short circuit occurring in the internal circuit of said anion-generating device.

8. The anion-generating device according to claim 1, wherein a first indicating device and a second indicating device connected to said controlling device, respectively, are further included, said first indicating device indicates the internal circuit of the anion-generating device is in a state of short circuit, and said second indicating device indicates the internal circuit of the anion-generating device is out of a state of short circuit.

9. The anion-generating device according to claim 8, wherein said first indicating device and said second indication device are light emitting diodes (LEDs).

10. The anion-generating device according to claim 1, wherein said logic controlling circuit is formed by a circuit substrate, and said high voltage power generating circuit is formed by another circuit substrate.

11. An anion-generating device, comprising:
a shell body, in which an accommodation space is formed therein, and an air inlet and an exhaust outlet are arranged on said shell body for facilitating the outside air to enter the device from said air inlet, to flow through the dust-collecting and anion-generating processes operated in said accommodation space, and to leave the device via said exhaust outlet;
an internal dust-collecting module, which is disposed in said shell body, including:
a first electrode portion, which is located adjacently to said air inlet and is grounded;
a second electrode portion including at least two conductive plates, said second electrode portion is located adjacently to said exhaust outlet and is connected to a negative high voltage power, said second electrode portion is used for adsorbing dust particles in the air flowing from said first electrode portion to said second electrode portion; and
a pinpoint array, which is arranged at the bottom of said exhaust outlet, is used for generating anions and spreading them in the air when the air flows through said internal dust-collecting module and leaves the device via said exhaust outlet;
it is characterized in that said internal dust-collecting module is a modular structure such that said modular structure can be taken out from or inserted into said anion-generating device in a whole.

12. The anion-generating device according to claim 11, wherein the internal dust-collecting module further comprises an upper lid such that said internal dust-collecting module and said upper lid are designed integrally as a whole.

13. The anion-generating device according to claim 11, wherein said first electrode portion is kept an appropriate distance from said second electrode portion, such that the air passes said first electrode portion and flows through the conductive plates of said second electrode portion.

14. The anion-generating device according to claim 11, said first electrode portion is constructed by two saw-tooth sheets with plurality of interlaced pinpoints.

15. The anion-generating device according to claim 11, wherein said second electrode portion is constructed by two conductive plates arranged in parallel, and said second electrode portion will be parallel to said first electrode portion by extending a certain distance toward said first electrode portion to make the first electrode portion located between the two conductive plates of the second electrode portion.

16. The anion-generating device according to claim 11, wherein a controlling device is further included, said controlling device comprising:
a logic controlling circuit, which is used for controlling the electrical operation of said anion-generating device and can automatically switch off the operation of said anion-generating device when a short circuit occurs in said first electrode portion and said second electrode portion;
a high voltage power generating circuit, which is connected to said logic controlling circuit and is controlled by said logic controlling circuit for generating a high voltage power needed by said second electrode portion.

17. The anion-generating device according to claim 11, wherein at least one switch is further included, said switch is connected to said controlling device and can resume the anion-generating device to normal operation when a short circuit occurring in the internal circuit of said anion-generating device.

18. The anion-generating device according to claim 11, wherein at least one indicating device is further included, said indicating device can indicate the working state of said anion-generating device.

19. The anion-generating device according to claim 11, wherein a first indicating device and a second indicating device are further included, said first indicating device indicates the internal circuit of the anion-generating device is in a state of short circuit, and said second indicating device indicates the internal circuit of the anion-generating device is out of a state of short circuit.

20. The anion-generating device according to claim 11, wherein said first indicating device and said second indication device are light emitting diodes (LEDs).

21. The anion-generating device according to claim 16, wherein said logic controlling circuit is formed by a circuit substrate, and said high voltage power generating circuit is formed by another circuit substrate.
